(19) United States
(12) Patent Application Publication
(10) Pub. No.: US 2026/0065409 A1
(43) Pub. Date: Mar. 5, 2026

(54) CACHE EFFICIENT FETCHES OF VERTEX BUFFER OBJECTS

(71) Applicant: QUALCOMM Incorporated, San Diego, CA (US)

(72) Inventors: Siva Satyanarayana KOLA, Bangalore (IN); Vishwanath Shashikant NIKAM, Bangalore (IN); Akash Sitaram ATHREYA, Bangalore (IN); Kalyan Kumar BHIRAVABHATLA, Bengaluru (IN)

(21) Appl. No.: 18/826,077

(22) Filed: Sep. 5, 2024

(51) Int. Cl. G06T 1/20; G06T 1/60

(52) U.S. Cl. CPC G06T 1/20; G06T 1/60

(57) ABSTRACT

This disclosure provides systems, devices, apparatus, and methods, including computer programs encoded on storage media, for improving the cache efficiency for fetching vertex buffer objects (VBOs). A graphics processor may determine that a logically contiguous segment of a vertex attribute buffer comprising a plurality of VBOs that include a first VBO element and a second VBO element is capable of being stored in a cache line (CL). The graphics processor may store the logically contiguous segment in the CL based on the determination. The graphics processor may retrieve the second VBO element from the CL after storage of the logically contiguous segment in the CL. The graphics processor may process the retrieved second VBO element in at least one of a binning pass or a rendering pass. The graphics processor may output an indication of the processed second VBO element.

### TECHNICAL FIELD

The present disclosure relates generally to processing systems, and more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques may not address optimizing cache efficiency for input attributes when processing graphics assets. There is a need for improved caching techniques for graphics assets.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus a memory; and at least one processor coupled to the memory and, based at least in part on information stored in the memory, the at least one processor may be configured to determine that a logically contiguous segment of a vertex attribute buffer including a plurality of vertex buffer objects (VBOs) that include a first VBO element and a second VBO element is capable of being stored in a cache line (CL). The at least one processor may be configured to store the logically contiguous segment including the first VBO element and the second VBO element in the CL based on the determination that the logically contiguous segment is capable of being stored in the CL. The at least one processor may be configured to retrieve the second VBO element from the CL after storage of the logically contiguous segment in the CL; processing the retrieved second VBO element in at least one of a binning pass or a rendering pass. The at least one processor may be configured to output an indication of the processed second VBO element. The at least one processor may be configured to obtain an indication of the vertex attribute buffer before the determination of whether the logically contiguous segment of the vertex attribute buffer including the plurality of VBOs is capable of being stored in the CL. The at least one processor may be configured to output the indication of the processed second VBO element by storing the indication of the processed second VBO element. The at least one processor may be configured to output the indication of the processed second VBO element by transmitting the indication of the processed second VBO element.

In some aspects, the techniques described herein relate to a method of graphics processing, including: determining that a logically contiguous segment of a vertex attribute buffer including a plurality of vertex buffer objects (VBOs) that include a first VBO element and a second VBO element is capable of being stored in a cache line (CL); storing the logically contiguous segment including the first VBO element and the second VBO element in the CL based on the determination that the logically contiguous segment is capable of being stored in the CL; retrieving the second VBO element from the CL after storage of the logically contiguous segment in the CL; processing the retrieved second VBO element in at least one of a binning pass or a rendering pass; and outputting an indication of the processed second VBO element.

In some aspects, the techniques described herein relate to a method, where outputting the indication of the processed second VBO element includes: storing the indication of the processed second VBO element; or transmitting the indication of the processed second VBO element.

In some aspects, the techniques described herein relate to a method, where the plurality of VBOs includes at least one of: a vertex specific attribute; an instance specific attribute; or an instanced attribute.

In some aspects, the techniques described herein relate to a method, where a first type of the first VBO element is different than a second type of the second VBO element.

In some aspects, the techniques described herein relate to a method, further including: determining that the logically contiguous segment of the vertex attribute buffer including the plurality of VBOs is capable of being stored in the CL before storage of the logically contiguous segment in the CL.

In some aspects, the techniques described herein relate to a method, where the vertex attribute buffer includes a plurality of instance specific attributes, where determining that the logically contiguous segment of the vertex attribute buffer including the plurality of VBOs is capable of being stored in the CL includes: determining a minimum instance identifier (ID) offset for any two instances of the vertex attribute buffer; and determining that the CL is associated with the first VBO element and the second VBO element in response to the determined minimum instance ID offset being less than a size of the CL.

In some aspects, the techniques described herein relate to a method, where determining the minimum instance ID offset for any two instances of the vertex attribute buffer includes: multiplying a VBO stride of the vertex attribute buffer with a minimum offset between any two instance specific attributes of the plurality of instance specific attributes.

In some aspects, the techniques described herein relate to a method, where the vertex attribute buffer includes a plurality of instance specific attributes, where determining that the logically contiguous segment of the vertex attribute buffer including the plurality of VBOs is capable of being stored in the CL includes: determining that the logically contiguous segment of the vertex attribute buffer including the plurality of VBOs is capable of being stored in the CL in response to a minimum offset between any two instance specific attributes of the plurality of instance specific attributes being less than a VBO step rate of the vertex attribute buffer.

In some aspects, the techniques described herein relate to a method, where the vertex attribute buffer includes a plurality of instance specific attributes, where determining that the logically contiguous segment of the vertex attribute buffer including the plurality of VBOs is capable of being stored in the CL includes: determining a minimum attribute offset for any two attributes of a first instance of the vertex attribute buffer; and determining that the logically contiguous segment of the vertex attribute buffer including the plurality of VBOs is capable of being stored in the CL in response to the determined minimum attribute offset being less than a size of the CL.

In some aspects, the techniques described herein relate to a method, where the vertex attribute buffer includes a plurality of vertex specific attributes, where determining that the logically contiguous segment of the vertex attribute buffer including the plurality of VBOs is capable of being stored in the CL includes: determining a minimum instance identifier (ID) offset for any two instances of the vertex attribute buffer; and determining that the logically contiguous segment of the vertex attribute buffer including the plurality of VBOs is capable of being stored in the CL in response to the determined minimum attribute offset being less than a size of the CL.

In some aspects, the techniques described herein relate to a method, where determining the minimum instance ID offset for any two instances of the vertex attribute buffer includes: multiplying a VBO stride of the vertex attribute buffer with a minimum offset between any two vertex specific attributes of the plurality of instance specific attributes.

In some aspects, the techniques described herein relate to a method, where the vertex attribute buffer includes a plurality of vertex specific attributes, where determining that the logically contiguous segment of the vertex attribute buffer including the plurality of VBOs is capable of being stored in the CL includes: determining that the logically contiguous segment of the vertex attribute buffer including the plurality of VBOs is capable of being stored in the CL in response to an instance count of the vertex attribute buffer being greater than one.

In some aspects, the techniques described herein relate to a method, where the vertex attribute buffer includes a plurality of vertex specific attributes, where determining that the logically contiguous segment of the vertex attribute buffer including the plurality of VBOs is capable of being stored in the CL includes: determining a minimum attribute offset for any two attributes of a first vertex of the vertex attribute buffer; and determining that the logically contiguous segment of the vertex attribute buffer including the plurality of VBOs is capable of being stored in the CL in response to the determined minimum attribute offset being less than a size of the CL.

In some aspects, the techniques described herein relate to a method, where determining that the logically contiguous segment of the vertex attribute buffer including the plurality of VBOs is capable of being stored in the CL includes: comparing a first draw call associated with the first VBO element with a second draw call associated with the second VBO element; and determining that the logically contiguous segment of the vertex attribute buffer including the plurality of VBOs is capable of being stored in the CL in response to the first draw call and the second draw call using a same buffer for the first VBO element and the second VBO element.

In some aspects, the techniques described herein relate to a method, further including: obtaining an indication of the vertex attribute buffer before the determination of whether the logically contiguous segment of the vertex attribute buffer including the plurality of VBOs is capable of being stored in the CL.

In an aspect of the disclosure, a method, a computer-readable medium, and an apparatus are provided. The apparatus a memory; and at least one processor coupled to the memory and, based at least in part on information stored in the memory, the at least one processor is configured to obtain an indication of a vertex attribute buffer including a plurality of vertex buffer objects (VBOs). The at least one processor may be configured to store both a current VBO element and a subsequent VBO element in a cache line (CL) based on a determination that the CL is associated with the current VBO element and the subsequent VBO element. The at least one processor may be configured to retrieve the subsequent VBO element from the CL in response to a storage of both the current VBO element and the subsequent VBO element in the CL. The at least one processor may be configured to process the retrieved subsequent VBO element in at least one of a binning pass or a rendering pass. The at least one processor may be configured to output an indication of the processed subsequent VBO element.

In some aspects, the techniques described herein relate to a method of graphics processing, including: obtaining an indication of a vertex attribute buffer including a plurality of vertex buffer objects (VBOs); storing both a current VBO element and a subsequent VBO element in a cache line (CL) based on a determination that the CL is associated with the current VBO element and the subsequent VBO element; retrieving the subsequent VBO element from the CL in response to a storage of both the current VBO element and the subsequent VBO element in the CL; processing the retrieved subsequent VBO element in at least one of a binning pass or a rendering pass; and outputting an indication of the processed subsequent VBO element.

In some aspects, the techniques described herein relate to a method, where outputting the indication of the processed subsequent VBO element includes: storing the indication of the processed subsequent VBO element; or transmitting the indication of the processed subsequent VBO element.

In some aspects, the techniques described herein relate to a method, where the plurality of VBOs includes at least one of: a draw call; a vertex; a vertex attribute; or a VBO instance.

In some aspects, the techniques described herein relate to a method, where a first type of the current VBO element is different than a second type of the subsequent VBO element.

In some aspects, the techniques described herein relate to a method, further including: determining whether the CL is associated with the current VBO element and the subsequent VBO element of the plurality of VBOs before the storage of both the current VBO element and the subsequent VBO element in the CL.

In some aspects, the techniques described herein relate to a method, where the vertex attribute buffer includes a plurality of instance specific attributes, where determining whether the CL is associated with the current VBO element and the subsequent VBO element of the plurality of VBOs includes: determining a minimum instance identifier (ID) offset for any two instances of the vertex attribute buffer; and determining that the CL is associated with the current VBO element and the subsequent VBO element in response to the determined minimum instance ID offset being less than a size of the CL.

In some aspects, the techniques described herein relate to a method, where determining the minimum instance ID offset for any two instances of the vertex attribute buffer includes: multiplying a VBO stride of the vertex attribute buffer with a minimum offset between any two instance specific attributes of the plurality of instance specific attributes.

In some aspects, the techniques described herein relate to a method, where the vertex attribute buffer includes a plurality of instance specific attributes, where determining whether the CL is associated with the current VBO element and the subsequent VBO element of the plurality of VBOs includes: determining that the CL is associated with the current VBO element and the subsequent VBO element in response to a minimum offset between any two instance specific attributes of the plurality of instance specific attributes being less than a VBO step rate of the vertex attribute buffer.

In some aspects, the techniques described herein relate to a method, where the vertex attribute buffer includes a plurality of instance specific attributes, where determining whether the CL is associated with the current VBO element and the subsequent VBO element of the plurality of VBOs includes: determining a minimum attribute offset for any two attributes of a first instance of the vertex attribute buffer; and determining that the CL is associated with the current VBO element and the subsequent VBO element in response to the determined minimum attribute offset being less than a size of the CL.

In some aspects, the techniques described herein relate to a method, where the vertex attribute buffer includes a plurality of vertex specific attributes, where determining whether the CL is associated with the current VBO element and the subsequent VBO element of the plurality of VBOs includes: determining a minimum instance identifier (ID) offset for any two instances of the vertex attribute buffer; and determining that the CL is associated with the current VBO element and the subsequent VBO element in response to the determined minimum attribute offset being less than a size of the CL.

In some aspects, the techniques described herein relate to a method, where determining the minimum instance ID offset for any two instances of the vertex attribute buffer includes: multiplying a VBO stride of the vertex attribute buffer with a minimum offset between any two vertex specific attributes of the plurality of instance specific attributes.

In some aspects, the techniques described herein relate to a method, where the vertex attribute buffer includes a plurality of vertex specific attributes, where determining whether the CL is associated with the current VBO element and the subsequent VBO element of the plurality of VBOs includes: determining that the CL is associated with the current VBO element and the subsequent VBO element in response to an instance count of the vertex attribute buffer being greater than one.

In some aspects, the techniques described herein relate to a method, where the vertex attribute buffer includes a plurality of vertex specific attributes, where determining whether the CL is associated with the current VBO element and the subsequent VBO element of the plurality of VBOs includes: determining a minimum attribute offset for any two attributes of a first vertex of the vertex attribute buffer; and determining that the CL is associated with the current VBO element and the subsequent VBO element in response to the determined minimum attribute offset being less than a size of the CL.

In some aspects, the techniques described herein relate to a method, where determining whether the CL is associated with the current VBO element and the subsequent VBO element of the plurality of VBOs includes: comparing a current draw call associated with the current VBO element with a subsequent draw call associated with the subsequent VBO element; and determining that the CL is associated with the current VBO element and the subsequent VBO element in response to the current draw call and the subsequent draw call using a same buffer for the current VBO element and the subsequent VBO element.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example GPU in accordance with one or more techniques of this disclosure.

FIG. 3 illustrates an example image or surface in accordance with one or more techniques of this disclosure.

FIG. 4A illustrates an example of a vertex buffer, in accordance with one or more techniques of this disclosure.

FIG. 4B illustrates an example of a vertex buffer, in accordance with one or more techniques of this disclosure.

FIG. 5A illustrates an example of a plurality of vertex attributes in a bin visibility pass, in accordance with one or more techniques of this disclosure.

FIG. 5B illustrates an example of a plurality of vertex attributes in a bin visibility pass, in accordance with one or more techniques of this disclosure.

FIG. 6A illustrates an example of a plurality of vertex attributes in a bin visibility pass, in accordance with one or more techniques of this disclosure.

FIG. 6B illustrates an example of a plurality of vertex attributes in a bin visibility pass, in accordance with one or more techniques of this disclosure.

FIG. 7A illustrates an example of a plurality of vertex attributes in a bin rendering pass, in accordance with one or more techniques of this disclosure.

FIG. 7B illustrates an example of a plurality of vertex attributes in a bin rendering pass, in accordance with one or more techniques of this disclosure.

FIG. 8A illustrates an example of a plurality of vertex attributes in a bin rendering pass, in accordance with one or more techniques of this disclosure.

FIG. 8B illustrates an example of a plurality of vertex attributes in a bin rendering pass, in accordance with one or more techniques of this disclosure.

FIG. 9 illustrates an example of a method of determining whether to allocate a set of cache lines of a vertex attribute buffer to a cache, in accordance with one or more techniques of this disclosure.

FIG. 10 illustrates an example of a method of determining whether to allocate a set of cache lines of a vertex attribute buffer to a cache, in accordance with one or more techniques of this disclosure.

FIG. 11 illustrates an example of a method of determining whether to allocate a set of cache lines of a vertex attribute buffer to a cache, in accordance with one or more techniques of this disclosure.

FIG. 12 is a call flow diagram illustrating example communications between a CPU and a GPU, in accordance with one or more techniques of this disclosure.

FIG. 13 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

The following description is directed to examples for the purposes of describing innovative aspects of this disclosure. However, a person having ordinary skill in the art may recognize that the teachings herein may be applied in a multitude of ways. Some or all of the described examples may be implemented in any device or system that is capable of processing graphics commands. Various aspects relate generally to reprojecting and/or composing frames for a graphics processing unit (GPU). Some aspects more specifically relate to applying reprojection fallback strategies during an excess system load (e.g., when a reprojection process for a frame will not complete in time to display the frame). For example, a graphics system may have limited dynamic random access memory (DRAM) bandwidth due to concurrent work (e.g., rendering, GPU workload, high-intensity periods of camera data acquisition), software control latencies (e.g., poorly optimized code, latencies when communicating with third-party applications), bottlenecking hardware execution, and/or power/thermal throttling. Such loads may affect the calculated projected time for a reprojection process to complete within a threshold period of time. Use of remotely-rendered framebuffers (e.g., frames processed by a reprojection topology on a separate system, or a third-party system), may also affect the time to render a frame. For example, use of a second reprojection process may conserve resources if a first reprojection process uses remote-rendered framebuffers having a high calculated latency value, or if a first reprojection process uses a large amount of bandwidth (e.g., WiFi, 5G bandwidth) and a system is configured to conserve use of that bandwidth with respect to transmission/reception of remote-rendered frames.

In some examples, a graphics processor (or graphics processor system) may determine that a logically contiguous segment of a vertex attribute buffer including a plurality of vertex buffer objects (VBOs) that include a first VBO element (e.g., current VBO element) and a second VBO element (e.g., subsequent VBO element) is capable of being stored in a cache line (CL). A vertex attribute buffer may be a data structure of a logically contiguous plurality of VBOs which may be traversed from one end of the data structure to the other end of the data structure in a binning pass or a rendering pass. A segment may be logically contiguous where the elements in the segment are arranged in a logically sequential list without other elements breaking up, being in between, or otherwise separating the elements when fetched in a pass (e.g., a binning pass, a rendering pass). In other words, the VBO elements in a logically contiguous segment may not have other elements not located in the segment logically in between two of the VBO elements in the logically contiguous segment when fetched in a pass. The vertex attribute buffer may be stored in a memory, for example an on-chip memory of a processor, system memory, or any other memory accessible by a processor. A vertex attribute buffer may include a set of graphics processor unit (GPU) vertex shader input attribute data. Such buffers may include vertex attribute data (e.g., per vertex based) or instance attribute data (e.g., per instance based, where all vertices of an instance use the same data). Such data may be present in one or multiple vertex attribute buffers. In other words, the vertex attribute buffer may not refer to a memory location, but rather a data structure which may be saved at a memory location (e.g., a system memory, an off-chip memory) where logically contiguous segments of the vertex attribute buffer may be fetched to be used in another memory location, for example in a CL. Where a logically contiguous segment includes a first VBO element and a second VBO element, the logically contiguous segment from the vertex attribute buffer may also include one or more VBO elements that are in between the first VBO element and the second VBO element in the vertex attribute buffer. Moreover, where a logically contiguous segment is saved in a CL of a given size, the CL that includes the logically contiguous segment that includes the first VBO element and the second VBO element (where the first VBO element is before the second VBO element in the vertex attribute buffer) may include VBO elements that are before the first VBO element in the vertex attribute buffer and/or may include VBO elements that are after the second VBO element in the vertex attribute buffer.

A VBO may include vertex specific attributes. A VBO may include instance specific attributes. A VBO may include one or more attributes (i.e., a set of attributes) associated with all vertices that correspond with a set of draws. A draw may include a set of instances. An instance may include a set of vertices. A vertex may include a set of vertex attributes. A vertex attribute may vary for every vertex (i.e., a vertex specific attribute). A vertex attribute may be the same for all vertices of a set of instances (e.g., instance-specific attribute, instanced attribute). An instanced attribute may be the same for all vertices of a set of instances associated with a set of draw calls. Where a vertex attribute is the same for all vertices of a plurality of instances, a processor may process each instance at a defined steprate.

The graphics processor may store the logically contiguous segment including the first VBO element and the second VBO element in the CL based on the determination that the logically contiguous segment is capable of being stored in the CL. A CL may be a line of cache memory which may be used by a GPU to access input attribute data from a vertex attribute buffer. A width of the CL (e.g., CL_width) may define the size of the cache, for example, a CL may have a width of 32 bytes or a width of 64 bytes. A VBO element may include any element of a vertex attribute buffer, such as a draw call, a vertex, a vertex attribute, or a VBO instance. The graphics processor may retrieve the second VBO element from the CL (e.g., via a fetch command) after storage of the logically contiguous segment in the CL. In other words, during a binning pass or a rendering pass, the graphics processor may fetch both the current VBO element and the subsequent VBO element from the same CL. The graphics processor may process the retrieved second VBO element in at least one of a binning pass or a rendering pass. The graphics processor may output an indication of the processed second VBO element.

In another embodiment, a graphics processor may obtain an indication of a vertex attribute buffer including a plurality of vertex buffer objects (VBOs). The graphics processor may store both a current VBO element and a subsequent VBO element in a cache line (CL) based on a determination that the CL is associated with the current VBO element and the subsequent VBO element. The graphics processor may retrieve the subsequent VBO element from the CL (e.g., via a fetch command) in response to a storage of both the current VBO element and the subsequent VBO element in the CL. The graphics processor may process the retrieved subsequent VBO element in at least one of a binning pass or a rendering pass. The graphics processor may output an indication of the processed subsequent VBO element. The logically contiguous segment saved in the CL may include VBO elements that are in between the first VBO element and the second VBO element in the vertex attribute buffer. Moreover, the logically contiguous segment saved in the CL may include one or more VBO elements that are before the first VBO element in the vertex attribute buffer (where the first VBO element is before the second VBO element in the vertex attribute buffer), and/or may include one or more VBO elements that are after the second VBO element in the vertex attribute buffer (where the first VBO element is before the second VBO element in the vertex attribute buffer). For example, in a CL that includes 4 VBO elements, where the first VBO element is the first VBO element in a vertex attribute buffer and the second VBO element is the second VBO element in the vertex attribute buffer, the CL may include the first, second, third, and fourth VBO elements in the vertex attribute buffer.

Particular aspects of the subject matter described in this disclosure can be implemented to realize one or more of the following potential advantages. In some examples, by dynamically storing both a current and a subsequent VBO element in the same CL, the described techniques can be used to optimize cache efficiency for input attributes of the VBO elements. Such techniques may minimize double data rate (DDR) bandwidth (BW) traffic by optimizing utilization of a last level cache (LLC). For example, such techniques implemented in Pakala™ may save up to 7.3% DDR traffic from a GPU with a 4 MB LLC.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

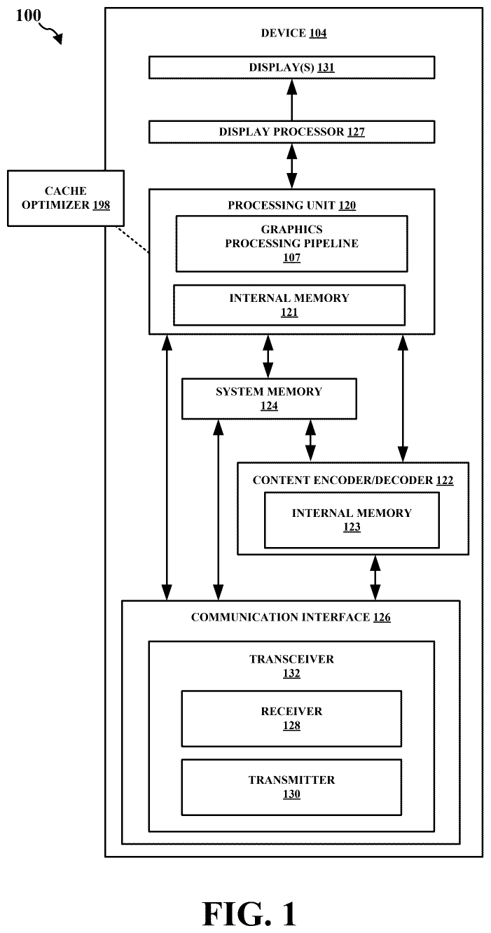

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104

Referring again to FIG. 1, in certain aspects, the processing unit 120 may include a cache optimizer 198 configured to obtain an indication of a vertex attribute buffer including a plurality of vertex buffer objects (VBOs). The cache optimizer 198 may be configured to store both a current VBO element and a subsequent VBO element in a cache line (CL) based on a determination that the CL is associated with the current VBO element and the subsequent VBO element. The cache optimizer 198 may be configured to retrieve the subsequent VBO element from the CL in response to a storage of both the current VBO element and the subsequent VBO element in the CL. The cache optimizer 198 may be configured to process the retrieved subsequent VBO element in at least one of a binning pass or a rendering pass. The cache optimizer 198 may be configured to output an indication of the processed subsequent VBO element.

Although the following description may be focused on graphics processing, the concepts described herein may be applicable to other similar processing techniques. A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicate which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

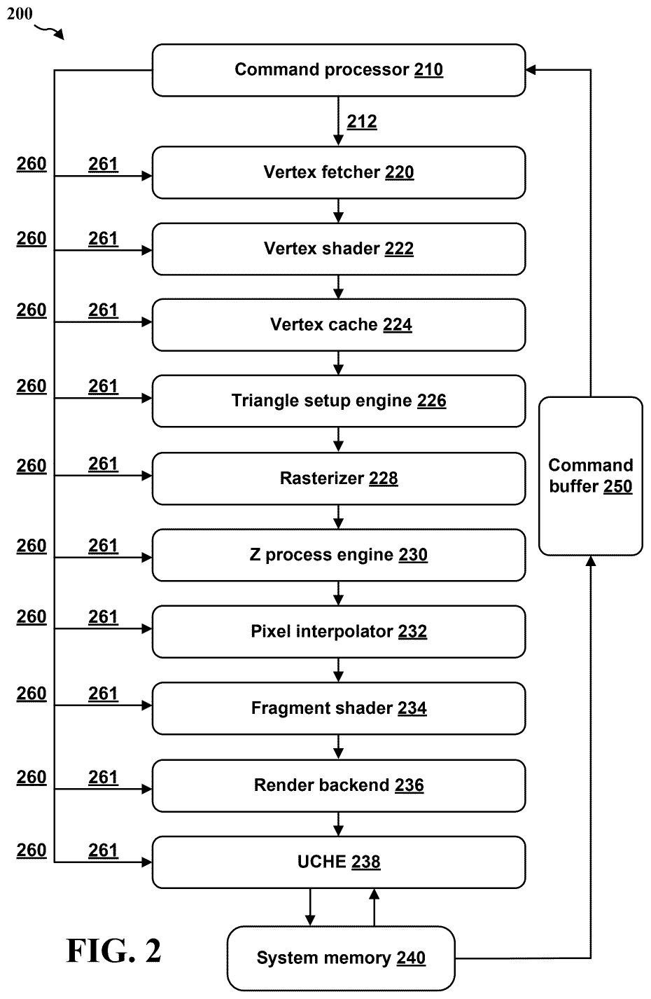

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects of tiled rendering, during a binning pass, an image can be divided into different bins or tiles. In some aspects, during the binning pass, a visibility stream can be constructed where visible primitives or draw calls can be identified. A rendering pass may be performed after the binning pass. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets may be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

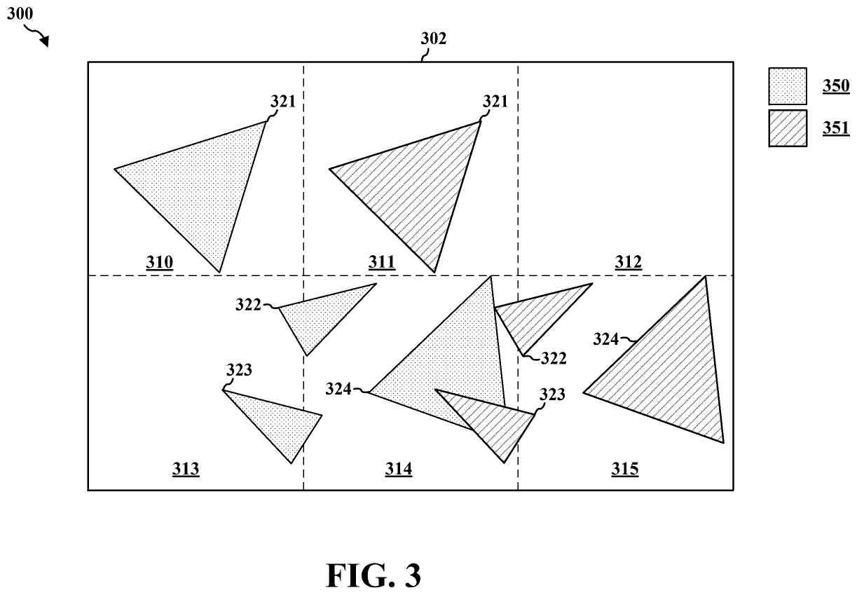

FIG. 3 illustrates image or surface 300, including multiple primitives divided into multiple bins in accordance with one or more techniques of this disclosure. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processors can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

As indicated herein, in some aspects, such as in bin or tiled rendering architecture, frame buffers can have data stored or written to them repeatedly, e.g., when rendering from different types of memory. This can be referred to as resolving and unresolving the frame buffer or system memory. For example, when storing or writing to one frame buffer and then switching to another frame buffer, the data or information on the frame buffer can be resolved from the GMEM at the GPU to the system memory, i.e., memory in the double data rate (DDR) RAM or dynamic RAM (DRAM).

In some aspects, the system memory can also be system-on-chip (SoC) memory or another chip-based memory to store data or information, e.g., on a device or smart phone. The system memory can also be physical data storage that is shared by the CPU and/or the GPU. In some aspects, the system memory can be a DRAM chip, e.g., on a device or smart phone. Accordingly, SoC memory can be a chip-based manner in which to store data.

In some aspects, the GMEM can be on-chip memory at the GPU, which can be implemented by static RAM (SRAM). Additionally, GMEM can be stored on a device, e.g., a smart phone. As indicated herein, data or information can be transferred between the system memory or DRAM and the GMEM, e.g., at a device. In some aspects, the system memory or DRAM can be at the CPU or GPU. Additionally, data can be stored at the DDR or DRAM. In some aspects, such as in bin or tiled rendering, a small portion of the memory can be stored at the GPU, e.g., at the GMEM. In some instances, storing data at the GMEM may utilize a larger processing workload and/or consume more power compared to storing data at the frame buffer or system memory.

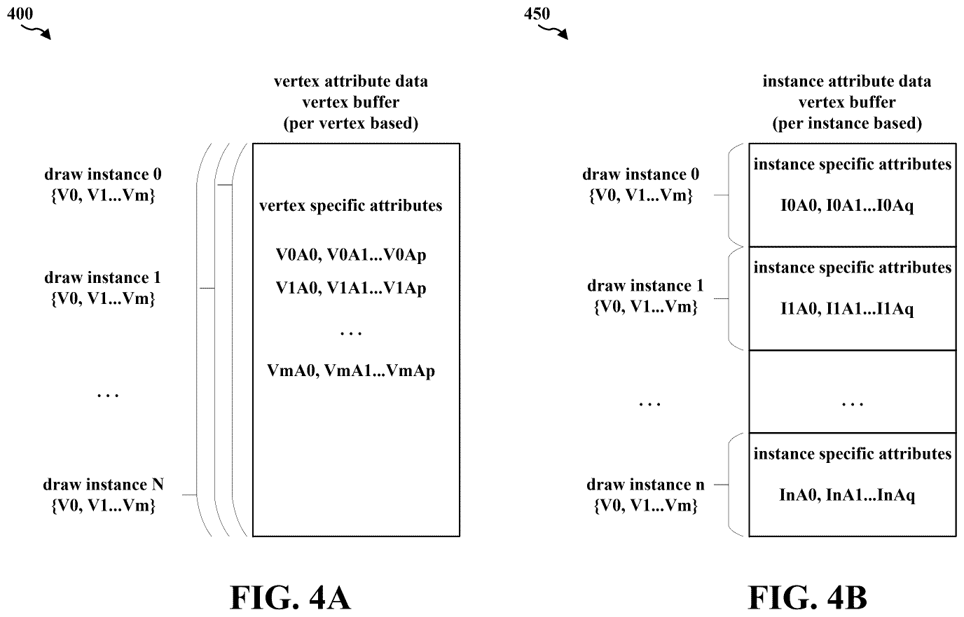

FIG. 4A illustrates a vertex buffer 400. The vertex buffer 400, also referred to as a vertex attribute buffer, may include input attribute data that a GPU may fetch and access via multiple levels of caches inside the GPU and system memory. The vertex buffer 400 may be a logically contiguous array of VBOs. A fetch to the vertex buffer 400 may fetch a logically contiguous segment of VBOs from the vertex buffer 400. The vertex buffer 400 may be stored on a memory, such as a system memory of an off-chip memory. As shown, a draw call may have N instances (also referred to as n instances when referring to individual attributes or an instance). A draw call may include a call instruction to draw a set of N instances. Each instance may have multiple vertices. Each instance may have m vertices. An instance may be a shape having a set of m vertices. Each vertex may have p vertex specific attributes. The p specific attributes may include vertex attributes that are not shared with other vertices of the index. Each instance may have q instance specific attributes.

The vertex buffer 400 may include p vertex specific attributes of m vertices, which may be the same for all of the N instances. The vertex buffer 400 may include an index to vertex attribute data, where each vertex has a set of attributes (A0-Ap), which are specific to that vertex. In other words, each of the p specific attributes for each vertex, from V0 to Vm, may not be shared with other vertices of the index. The instances, from I0 to In may share the same vertex data. In other words, the vertex buffer 400 may include a single instance of vertex data that is associated with each of the instances from 10 to In.

FIG. 4B illustrates a vertex buffer 450. The vertex buffer 450, also referred to as a vertex attribute buffer, may include input attribute data that a GPU may fetch and access via multiple levels of caches inside the GPU and system memory. The vertex buffer 450 may be a logically contiguous array of VBOs. A fetch to the vertex buffer 450 may fetch a logically contiguous segment of VBOs from the vertex buffer 450. The vertex buffer 450 may be stored on a memory, such as a system memory of an off-chip memory. As shown, a draw call may have N instances (also referred to as n instances when referring to individual attributes or an instance). A draw call may include a call instruction to draw a set of N instances. Each instance may have multiple vertices. Each instance may have m vertices. An instance may be a shape having a set of m vertices. All vertices of an instance may use the same data. Each vertex may have p vertex specific attributes. The p specific attributes may include vertex attributes that are not shared with other vertices of the index. Each instance may have q instance specific attributes.

The vertex buffer 450 may include instance specific q number of attributes, which may be the same for all of the p number of vertices in each instance. The instance specific attributes for each draw instance may be the same for each instance, or a group of instances. The group of instances may be indicated by a steprate. For example, the vertex buffer 450 may illustrate a group of instances with a steprate of 1. The vertex buffer 450 may include an index to instance attribute data, where each vertex has a set of attributes (A0-Aq), which are shared with other vertices of the same instance index. In other words, each of the q specific attributes for each instance, from V0 to Vm, may be shared with other vertices of the same instance index. As such, all of the vertices of I0 may share the same q specific attributes, all the vertices of I1 may share the same q specific attributes, and so on, until In. The instances, from I0 to In may share the same vertex data.

A GPU architecture may support tile based deterred rendering (TBDR), where the render target (also referred to as a frame target) may be divided into smaller tiles called bins. The depth and color data of the render target may be resident in on-chip graphics memory (GMEM). In other words, the GPU may fetch depth and color data of the render target to the GMEM to process the depth and color data rapidly. The GPU may render each bin at a time, reducing the memory access bandwidth (BW) to the GMEM. The GPU may perform TBDR in two passes—a binning pass (e.g., generating a triangle visibility stream), and a rendering pass (e.g., using the generated visibility stream to draw those pixels that are visible in that bin).

A GPU may support TBDR with a concurrent binning (CB) scheme. For example, a GPU utilizing a CB scheme may start the binning, or bin visibility (BV), pass concurrently with the bin rendering (BR) pass of a previous render target. Separate BV pipe hardware may be used to support such concurrency. In other words, the BV pipe hardware may be separate from the BR pipe hardware to allow the BV pass of a current render target and the BR pass of a previous render target to run concurrently. The BV and BR pipelines may run in parallel. The BV pipeline may use a shared shader processor and memory subsystem resources with the BR pipeline for parallelly executing both passes. For example, memory subsystem caches may be shared across the BV pipeline and the BR pipeline.

The input attribute fetch standards for the BV pass and the BR pass may be different. For example, the BR pass may use all of the input attributes while the BV pass may use a subset of the input attributes for generating a position. In another example, the BV pass may use attribute data for all of the vertices of a draw call while a BR pass may access a subset of vertices corresponding with visible primitives. As a result, there may be unique challenges in caching input attribute data.

In some aspects, instance attribute data may be reused across multiple instances. In some aspects, vertex attribute data may be reused across multiple instances (e.g., where the instance count is greater than 1). In some aspects, vertex attribute data may be reused across multiple vertices. In some aspects, attribute data from a draw call may be used across multiple draw calls. In some aspects, a subset of attributes of a draw call may be reused across an instance of other draw calls. In such aspects, saving such data in a GMEM, or a CL, may improve the performance of a BR pass or a BV pass. However, due to the dynamic nature of BR/BV passes (e.g., the variable size of draw calls, variable number of instances), designing a cache sub-system size which takes advantage of both reuse cases may be challenging. In some aspects, different reuses cases may be used simultaneously in an interleaving manner at each vertex granularity and/or instance granularity. For example, depending on the cache size, a vertex attribute may trash instance attribute data, or instance attribute data may trash vertex attribute data.

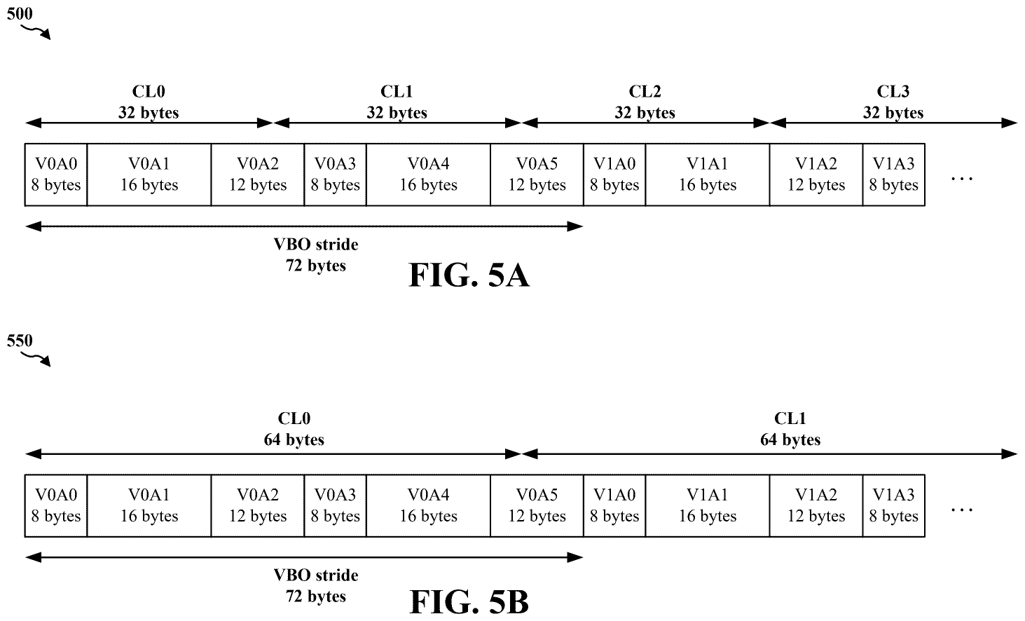

FIG. 5A is a diagram 500 illustrating a plurality of vertex attributes in a bin visibility pass. Each vertex may have six attributes. In other words, each VBO element of a vertex may have six attributes. For example, for vertex 0, the vertex attributes may include vertex 0 attribute 0 (V0A0) having a size of 8 bytes, vertex 0 attribute 1 (V0A1) having a size of 16 bytes, vertex 0 attribute 2 (V0A2) having a size of 12 bytes, vertex 0 attribute 3 (V0A3) having a size of 8 bytes, vertex 0 attribute 4 (V0A4) having a size of 16 bytes, and vertex 0 attribute 5 (V0A5) having a size of 12 bytes. Similarly, for vertex 1, the vertex attributes may include vertex 1 attribute 0 (V1A0) having a size of 8 bytes, vertex 1 attribute 1 (V1A1) having a size of 16 bytes, vertex 1 attribute 2 (V1A2) having a size of 12 bytes, vertex 1 attribute 3 (V1A3) having a size of 8 bytes, vertex 1 attribute 4 (V1A4) having a size of 16 bytes, and vertex 1 attribute 5 (V1A5) having a size of 12 bytes. The pattern may continue with each vertex.

The VBO stride for a vertex may be 72 bytes. The size of each CL (e.g., CL0, CL1, CL2, CL3 . . . ) may be 32 bytes. Attribute 0 (A0) may be in a position input attribute, which may be used in position shaders. As one position attribute to the next position attribute gap may be larger than the CL size (i.e., 72 bytes>32 bytes), caching such lines may not be useful, as a subsequent vertex attribute may not be in the same CL as the current vertex attribute.

FIG. 5B is a diagram 550 illustrating a plurality of vertex attributes in a bin visibility pass. Each vertex may have six attributes. In other words, each VBO element of a vertex may have six attributes. For example, for vertex 0, the vertex attributes may include vertex 0 attribute 0 (V0A0) having a size of 8 bytes, vertex 0 attribute 1 (V0A1) having a size of 16 bytes, vertex 0 attribute 2 (V0A2) having a size of 12 bytes, vertex 0 attribute 3 (V0A3) having a size of 8 bytes, vertex 0 attribute 4 (V0A4) having a size of 16 bytes, and vertex 0 attribute 5 (V0A5) having a size of 12 bytes. Similarly, for vertex 1, the vertex attributes may include vertex 1 attribute 0 (V1A0) having a size of 8 bytes, vertex 1 attribute 1 (V1A1) having a size of 16 bytes, vertex 1 attribute 2 (V1A2) having a size of 12 bytes, vertex 1 attribute 3 (V1A3) having a size of 8 bytes, vertex 1 attribute 4 (V1A4) having a size of 16 bytes, and vertex 1 attribute 5 (V1A5) having a size of 12 bytes. The pattern may continue with each vertex.

The VBO stride for a vertex may be 72 bytes. The size of each CL (e.g., CL0, CL1 . . . ) may be 64 bytes. Attribute 0 (A0) may be in a position input attribute, which may be used in position shaders. As one position attribute to the next position attribute gap may be larger than the CL size (i.e., 72 bytes>64 bytes), caching such lines may not be useful, as a subsequent vertex attribute may not be in the same CL as the current vertex attribute.

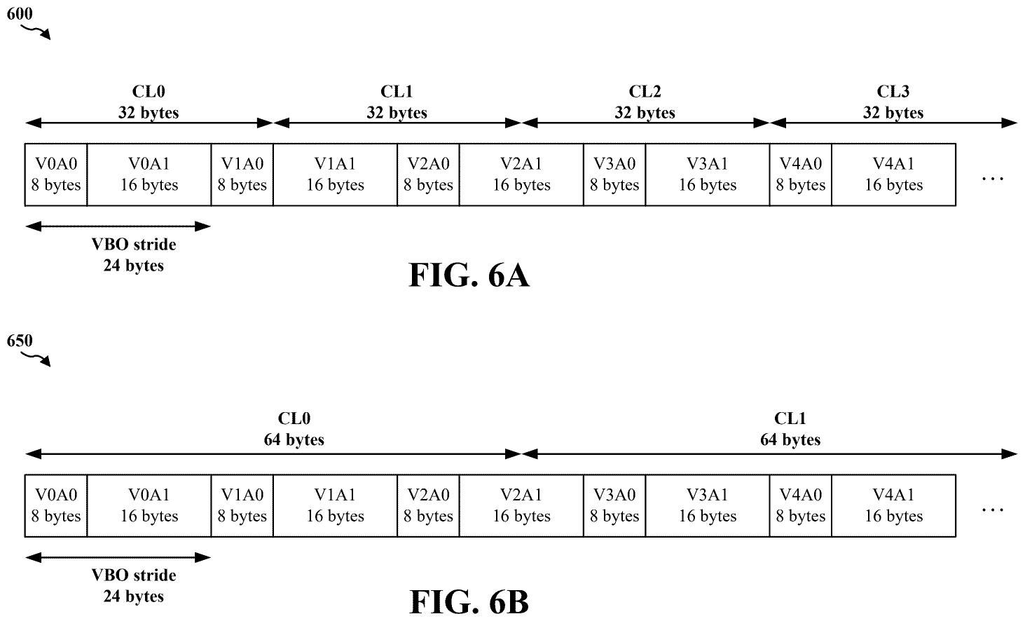

FIG. 6A is a diagram 600 illustrating a plurality of vertex attributes in a bin visibility pass. Each vertex may have two attributes. In other words, each VBO element of a vertex may have two attributes. For example, for vertex 0, the vertex attributes may include vertex 0 attribute 0 (V0A0) having a size of 8 bytes, and vertex 0 attribute 1 (V0A1) having a size of 16 bytes. Similarly, for vertex 1, the vertex attributes may include vertex 1 attribute 0 (V1A0) having a size of 8 bytes, and vertex 1 attribute 1 (V1A1) having a size of 16 bytes. The pattern may continue with each vertex.

The VBO stride for a vertex may be 24 bytes. The size of each CL (e.g., CL0, CL1, CL2, CL3 . . . ) may be 32 bytes. Attribute 0 (A0) may be in a position input attribute, which may be used in position shaders. As one position attribute to the next position attribute gap may be smaller than the CL size (i.e., 24 bytes<32 bytes), caching such lines may be useful, as a subsequent vertex attribute may be in the same CL as the current vertex attribute. For example, the attribute 0 for V1 (V1A0) may be in the same CL as another attribute from V0 (e.g., V0A0 or V0A1).

FIG. 6B is a diagram 650 illustrating a plurality of vertex attributes in a bin visibility pass. Each vertex may have two attributes. In other words, each VBO element of a vertex may have two attributes. For example, for vertex 0, the vertex attributes may include vertex 0 attribute 0 (V0A0) having a size of 8 bytes, and vertex 0 attribute 1 (V0A1) having a size of 16 bytes. Similarly, for vertex 1, the vertex attributes may include vertex 1 attribute 0 (V1A0) having a size of 8 bytes, and vertex 1 attribute 1 (V1A1) having a size of 16 bytes. The pattern may continue with each vertex.

The VBO stride for a vertex may be 24 bytes. The size of each CL (e.g., CL0, CL1, CL2, CL3 . . . ) may be 64 bytes. Attribute 0 (A0) may be in a position input attribute, which may be used in position shaders. As one position attribute to the next position attribute gap may be smaller than the CL size (i.e., 24 bytes<64 bytes), caching such lines may be useful, as a subsequent vertex attribute may be in the same CL as the current vertex attribute. For example, the attribute 0 for V2 (V2A0) may be in the same CL as another attribute from V0 (e.g., V0A0 or V0A1) or another attribute from V1 (e.g., V1A0 or V1A1).

In a bin visibility pass, an attribute fetch may be limited to a subset of attributes, as attributes contributing to determining a position are fetched during a BV pass. Depending upon the VBO layout, in certain cases a BV pass request may have minimal re-use, as shown in FIGS. 5A and 5B. In other cases, as shown in FIGS. 6A and 6B, a BV pass attribute request may be beneficial for caching on a chip cache (e.g., GMEM).

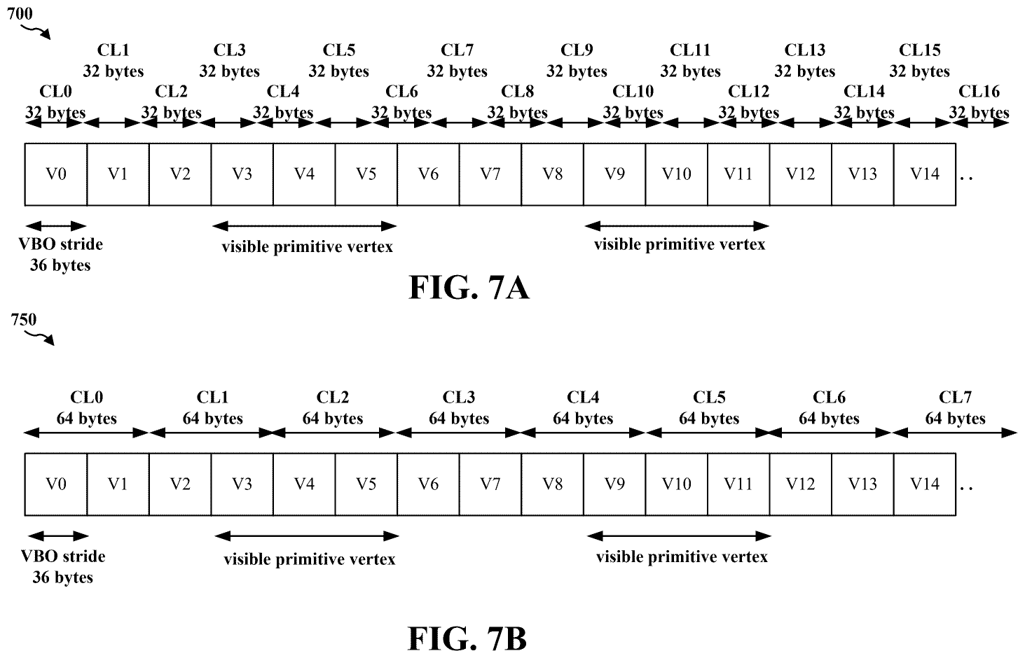

FIG. 7A is a diagram 700 illustrating a plurality of vertex attributes in a bin rendering pass. Each draw call may have a VBO stride of 36 bytes per vertex, where every three consecutive vertices form a triangle. In a bin render pass, a GPU may access visible primitive vertices, and may not access invisible primitive vertices. While a buffer may have multiple vertices, the fetched vertices may not be sequential. For example, a GPU may fetch the visible primitive vertices V3, V4, and V5, and also the visible primitive vertices V9, V10, and V11. Based on the visible primitive vertex span and the VBO stride, caching may be beneficial if multiple usable attributes are present in the same CL.

The VBO stride for a vertex may be 36 bytes. The CL may refer to level 1 (L1) cache or level 2 (L2) cache. The size of each CL (e.g., CL0, CL1, CL2, CL3 . . . ) may be 32 bytes. Attribute 0 (A0) may be in a position input attribute, which may be used in position shaders. As one position attribute to the next position attribute gap may be larger than the CL size (i.e., 36 bytes>32 bytes), caching such lines may not be useful, as a subsequent vertex attribute may not be in the same CL as the current vertex attribute.

FIG. 7B is a diagram 750 illustrating a plurality of vertex attributes in a bin rendering pass. Each draw call may have a VBO stride of 36 bytes per vertex, where every three consecutive vertices form a triangle. In a bin render pass, a GPU may access visible primitive vertices, and may not access invisible primitive vertices. While a buffer may have multiple vertices, the fetched vertices may not be sequential. For example, a GPU may fetch the visible primitive vertices V3, V4, and V5, and also the visible primitive vertices V9, V10, and V11. Based on the visible primitive vertex span and the VBO stride, caching may be beneficial if multiple usable attributes are present in the same CL.

The VBO stride for a vertex may be 36 bytes. The CL may refer to a last level cache (LLC). The size of each CL (e.g., CL0, CL1, CL2, CL3 . . . ) may be 64 bytes. Attribute 0 (A0) may be in a position input attribute, which may be used in position shaders. As one position attribute to the next position attribute gap may be larger than the CL size (i.e., 36 bytes<64 bytes), caching such lines may be useful, as a subsequent vertex attribute may be in the same CL as the current vertex attribute.

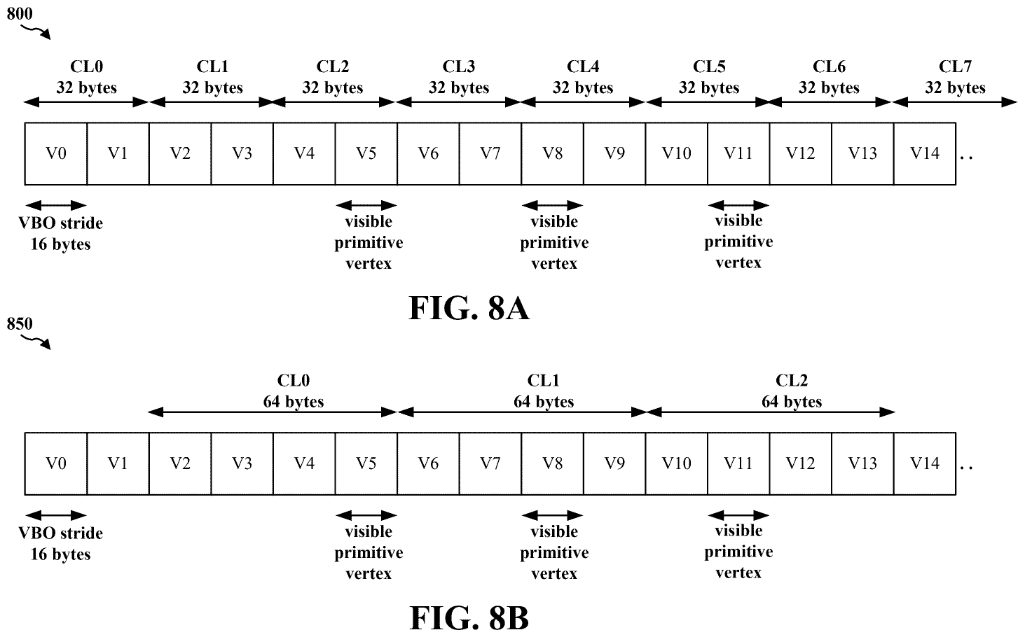

FIG. 8A is a diagram 800 illustrating a plurality of vertex attributes in a bin rendering pass. Each draw call may have a VBO stride of 16 bytes per vertex. V5, V8, and V11 may form visible primitives. In a bin render pass, a GPU may access visible primitive vertices, and may not access invisible primitive vertices. While a buffer may have multiple vertices, the fetched vertices may not be sequential. For example, a GPU may fetch the visible primitive vertices V5, V8, and V11, but not the other vertices less than V14. Based on the visible primitive vertex span and the VBO stride, caching may be beneficial if multiple usable attributes are present in the same CL.

The VBO stride for a vertex may be 16 bytes. The CL may refer to level 1 (L1) cache or level 2 (L2) cache. The size of each CL (e.g., CL0, CL1, CL2, CL3 . . . ) may be 32 bytes. Attribute 0 (A0) may be in a position input attribute, which may be used in position shaders. As the next subsequent vertex may not be in the same CL as the current vertex for the BR pass, caching such lines may not be useful, as a subsequent vertex attribute may not be in the same CL as the current vertex attribute.

FIG. 8B is a diagram 850 illustrating a plurality of vertex attributes in a bin rendering pass. Each draw call may have a VBO stride of 16 bytes per vertex. V5, V8, and V11 may form visible primitives. In a bin render pass, a GPU may access visible primitive vertices, and may not access invisible primitive vertices. While a buffer may have multiple vertices, the fetched vertices may not be sequential. For example, a GPU may fetch the visible primitive vertices V5, V8, and V11, but not the other vertices less than V14. Based on the visible primitive vertex span and the VBO stride, caching may be beneficial if multiple usable attributes are present in the same CL.

The VBO stride for a vertex may be 16 bytes. The CL may refer to LLC cache. The size of each CL (e.g., CL0, CL1, CL2, CL3 . . . ) may be 64 bytes. Attribute 0 (A0) may be in a position input attribute, which may be used in position shaders. As the next subsequent vertex may not be in the same CL as the current vertex for the BR pass, caching such lines may not be useful, as a subsequent vertex attribute may not be in the same CL as the current vertex attribute.

Since the vertex fetch order of vertices in a BR pass may not be sequential, in certain cases, as shown in FIGS. 7A, 8A, and 8B, a GPU may not benefit from caching input attribute data. On the other hand, in other cases, as shown in FIG. 7B, a GPU may benefit from caching input attribute data.

In some aspects, a cache optimizer may collect variables from a draw call state (e.g., draw call state information) to determine whether it will be beneficial to cache a set of VBOs in a CL. The collected variables may include any of the following:

| | |
|---|---|
| MAX_VBO | Max number of VBOs |
| MAX_ATTR | Max number of input attributes |
| Num_VTX_ATTR | Number of VS input Vertex specific |
| | attributes |
| Num_INST_ATTR | Number of VS input instance specific |
| | attributes |
| VBO_base | Vertex buffer base address |
| [MAX_VBO] | |
| VBO_Stride | Vertex buffer stride for each vertex |
| [MAX_VBO] | or instance |
| VBO_ID | Attribute Vertex buffer id |
| [MAX_ATTR] | |
| Attr_offset | Attribute offset within VBO stride. |
| [MAX_ATTR] | |
| Attr_step_rate | Attribute steprate |
| [MAX_ATTR] | |
| Num_instances | Number of instances in draw |
| Draw call size | Draw call size |
| Cache_line_width | Number of bytes in each cache line |
| Vertex_ids[N] | Next N sequential VS input vertex Ids in |
| | input order (N can be chosen based on |
| | HW PPA requirements) |
| Instance_ids[M] | Next M instance Ids in input order |
| | (M can be chosen based on HW PPA |
| | requirements) |

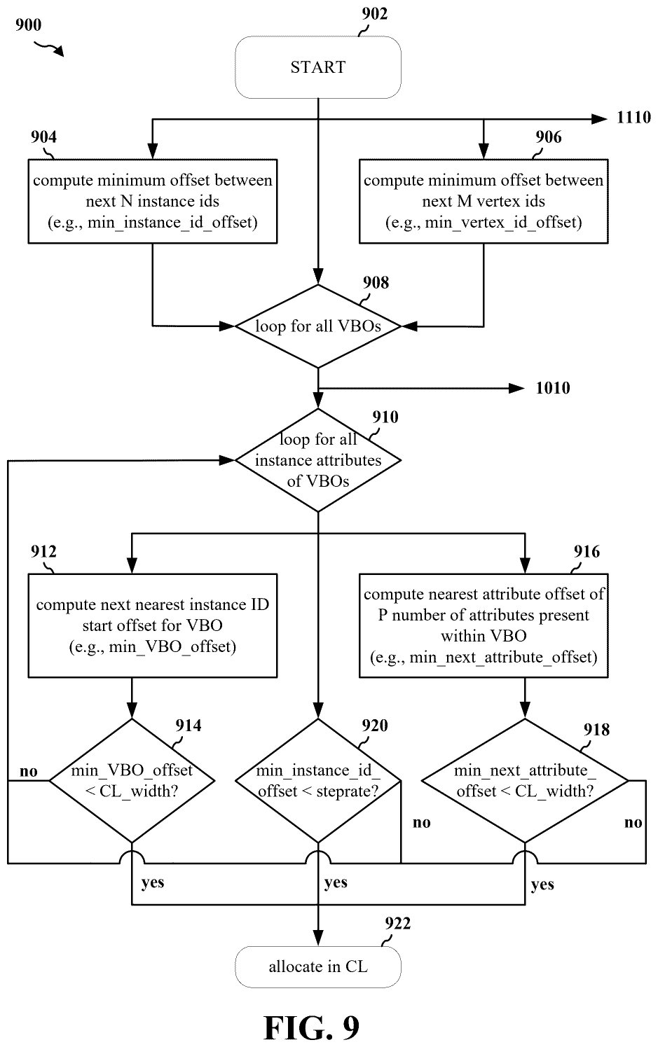

FIG. 9 is a diagram 900 of a portion of a method of determining whether to allocate a set of cache lines of a vertex attribute buffer to a cache. At 902, a cache optimizer may start to determine whether to allocate a set of cache lines of a vertex attribute buffer (e.g., a logically contiguous segment of VBOs) to a cache. The cache optimizer may collect the state data, such as the variables above, for a current draw call and a set of subsequent draw calls (e.g., the next “X” draw calls), and vertex attribute buffer information (e.g., the current draw vertex ID, the current draw instance ID) to determine whether a logically contiguous segment of the vertex attribute buffer that includes a current and a subsequent VBO can be stored in a CL. In some aspects, the cache optimizer may determine a minimum distance between the next set of “N” vertex IDs and the next set of “M” instance IDs which are in the queue for a fetch, to evaluate each one of the vertex/instances in that set and determine if there will be an advantage to storing a logically contiguous segment starting from the ID in the CL. If there is an advantage, then the cache optimizer may store the logically contiguous segment in the CL to retrieve multiple VBOs from the CL. If there is not an advantage, then the cache optimizer may forego storing the logically contiguous segment in the CL, and retrieve the VBOs directly from the storage where the vertex attribute buffer is stored (e.g., off-chip memory).

At 904, the cache optimizer may compute a minimum offset between the next N instance identifiers (IDs). The computed minimum offset may be referred to as min_instance_id_offset. At 906, the cache optimizer may computer the minimum offset between the next M vertex IDs. The computed minimum offset may be referred to as min_vertex_id_offset. At 908, the cache optimizer may loop for all VBOs in a vertex buffer.

At 910, the cache optimizer may loop for all instance attributes of VBOs in a vertex buffer. At 912, the cache optimizer may compute the next nearest instance ID start offset for the VBOs. The computed minimum offset may be referred to as min_VBO_offset, which may be calculated as a product of the minimum offset within the next M instances (min_instance_ID_offset) and the VBO stride. At 914, the cache optimizer may determine whether the min_VBO_offset is less than the width of the CL (CL_width). If so, at 922, the cache optimizer may allocate the VBO elements in the CL. If not, the cache optimizer may not allocate the VBO elements in the CL.

At 916, the cache optimizer may compute the next nearest attribute offset of P number of attributes present within a VBO. The computed nearest attribute offset may be referred to as min_next_attribute_offset, and may be determined as a minimum offset from a current fetch attribute to the next attribute within the same vertex attribute buffer. In other words, the cache optimizer may determine the minimum offset for each offset from A0 to Ap (e.g., min_next_attribute_offset=min (A0 offset, A1 offset, . . . Ap offset)) for an instance. At 918, the cache optimizer may determine whether the min_next_attribute_offset is less than the CL_width. If so, at 922, the cache optimizer may allocate the VBO elements in the CL. If not, the cache optimizer may not allocate the VBO elements in the CL.

At 920, the cache optimizer may determine whether a min_instance_id_offset is less than the step rate. If so, at 922, the cache optimizer may allocate the VBO elements in the CL. If not, the cache optimizer may not allocate the VBO elements in the CL.

The checks at 914, at 920, and at 918 may be referred to as instance attribute cache allocation checks. For example, the check at 914 may be a granule hit check between the next M instance IDs, where the min_VBO_offset (i.e., min_instance_ID_offset*VBO_stride) may indicate whether a request has any overlap with other requests in the queue. If so, then storing a logically contiguous segment of the vertex attribute buffer from the current instance ID in the CL may result in an advantage, as the attribute for the current and a subsequent request may be made from the same CL. In another example, the check at 918 may be a granule hit check between multiple attributes of an instance. The minimum offset from the current fetch attribute to the next attribute within the same vertex attribute buffer (min_next_attribute_offset) may indicate whether a request has any overlap across attributes. If so, then storing a logically contiguous segment of the vertex attribute buffer from the current instance ID in the CL may result in an advantage, as the attribute for the current and a subsequent request may be made from the same CL. In another example, the check at 920 may be a check to determine if there is a reuse hit across multiple instances. A step rate greater than 1 of an instance attribute may indicate that an attribute is reused across instances. In other words, the step rate may indicate how many instances are using the same instance data. If so, then storing a logically contiguous segment of the vertex attribute buffer from the current instance ID in the CL may result in an advantage, as the attribute for the current and a subsequent request may be made from the same CL.

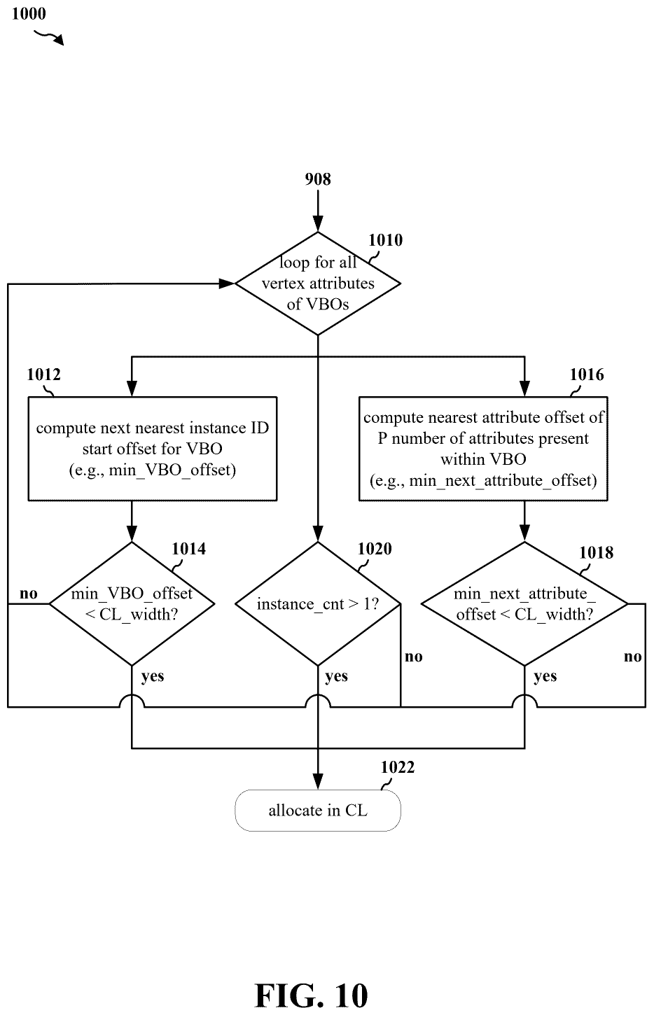

FIG. 10 is a diagram 1000 of a portion of a method of determining whether to allocate a set of cache lines of a vertex attribute buffer to a cache. 1010 may be navigated to from 908 in FIG. 9. At 1010, the cache optimizer may loop for all vertex attributes of VBOs in a vertex buffer.

At 1012, the cache optimizer may compute the next nearest instance ID start offset for the VBOs. The computed minimum offset may be referred to as min_VBO_offset. The cache optimizer may calculate the next nearest instance ID start offset be multiplying the minimum offset within the next V vertex IDs (min_vertex_id_offset) against the VBO stride (e.g., min_VBO_offset=min_vertex_id_offset*VBO_stride). At 1014, the cache optimizer may determine whether the min_VBO_offset is less than the CL_width. If so, at 1022, the cache optimizer may allocate the VBO elements in the CL. If not, the cache optimizer may not allocate the VBO elements in the CL.

At 1016, the cache optimizer may compute the next nearest attribute offset of P number of attributes present within a VBO. The computed nearest attribute offset may be referred to as min_next_attribute_offset, and may be determined as a minimum offset from a current fetch attribute to the next attribute within the same vertex attribute buffer. In other words, the cache optimizer may determine the minimum offset for each offset from A0 to Ap (e.g., min_next_attribute_offset=min (A0 offset, A1 offset, . . . . Ap offset)) for a vertex. At 1018, the cache optimizer may determine whether the min_next_attribute_offset is less than the CL_width. If so, at 1022, the cache optimizer may allocate the VBO elements in the CL. If not, the cache optimizer may not allocate the VBO elements in the CL.

At 1020, the cache optimizer may determine whether the number of instances (e.g., instance_cnt) is greater than one. If so, at 1022, the cache optimizer may allocate the VBO elements in the CL. If not, the cache optimizer may not allocate the VBO elements in the CL.

The checks at 1014, at 1020, and at 1018 may be referred to as vertex attribute cache allocation checks. For example, the check at 1014 may be a granule hit check between the next N vertex IDs, where the min_VBO_offset (i.e., min_vertex_id_offset VBO_stride) may indicate whether a request has any overlap with other requests in the queue. If so, then storing a logically contiguous segment of the vertex attribute buffer from the current vertex ID in the CL may result in an advantage, as the attribute for the current and a subsequent request may be made from the same CL. In another example, the check at 1018 may be a granule hit check between multiple attributes of a vertex. The minimum offset from the current fetch attribute to the next attribute within the same vertex attribute buffer (min_next_attribute_offset) may indicate whether a request has any overlap across attributes. If so, then storing a logically contiguous segment of the vertex attribute buffer from the current vertex ID in the CL may result in an advantage, as the attribute for the current and a subsequent request may be made from the same CL. In another example, the check at 1020 may be a check to determine if there is a reuse hit across multiple instances. An instance count greater than 1 may indicate how many instances are using the same vertices. If so, then storing a logically contiguous segment of the vertex attribute buffer from the current vertex ID in the CL may result in an advantage, as the attribute for the current and a subsequent request may be made from the same CL.

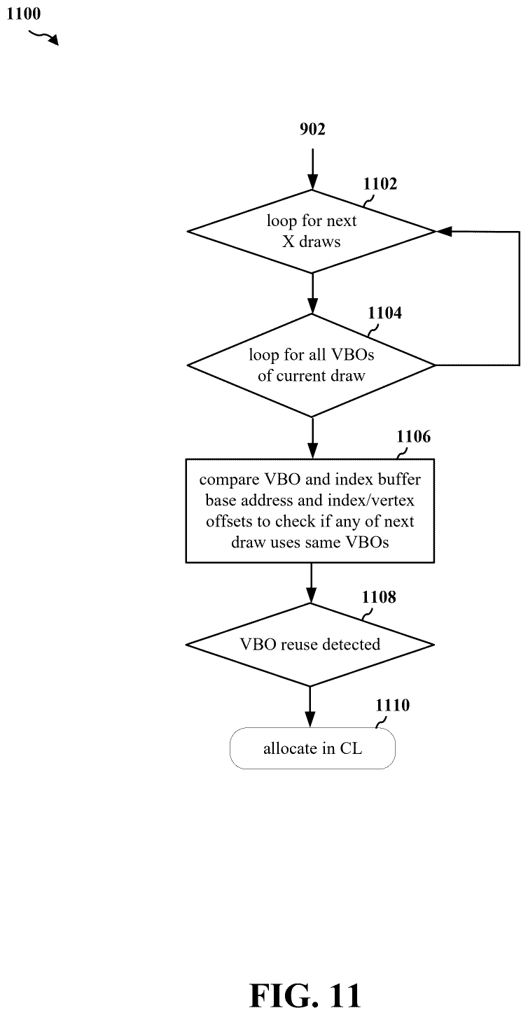

FIG. 11 is a diagram 1100 of a portion of a method of determining whether to allocate a set of cache lines of a vertex attribute buffer to a cache. 1102 may be navigated to from 902 in FIG. 9. At 1102, the cache optimizer may loop for the next X draws. At 1104, the cache optimizer may loop for all VBOs of the current draw call. At 1106, the cache optimizer may compare the VBO index buffer base address and index/vertex offsets to determine if any of the next draw calls use the same VBOs as the current draw call. At 1108, if a VBO reuse between draw calls is detected, at 1110, the cache optimizer may allocate the VBO elements in the CL. If not, the cache optimizer may not allocate the VBO elements in the CL. Such a check may be referred to as an access draw VBO reuse check. In other words, the cache optimizer may check if a logically contiguous segment of the vertex attribute buffer saved in the CL may be reused across multiple draws. Based on the cache allocation corresponding input attributes, the cache optimizer may determine if there is a reuse across draws where the VBOs, index buffers, and offsets, for the same input attribute data is reused across draws.

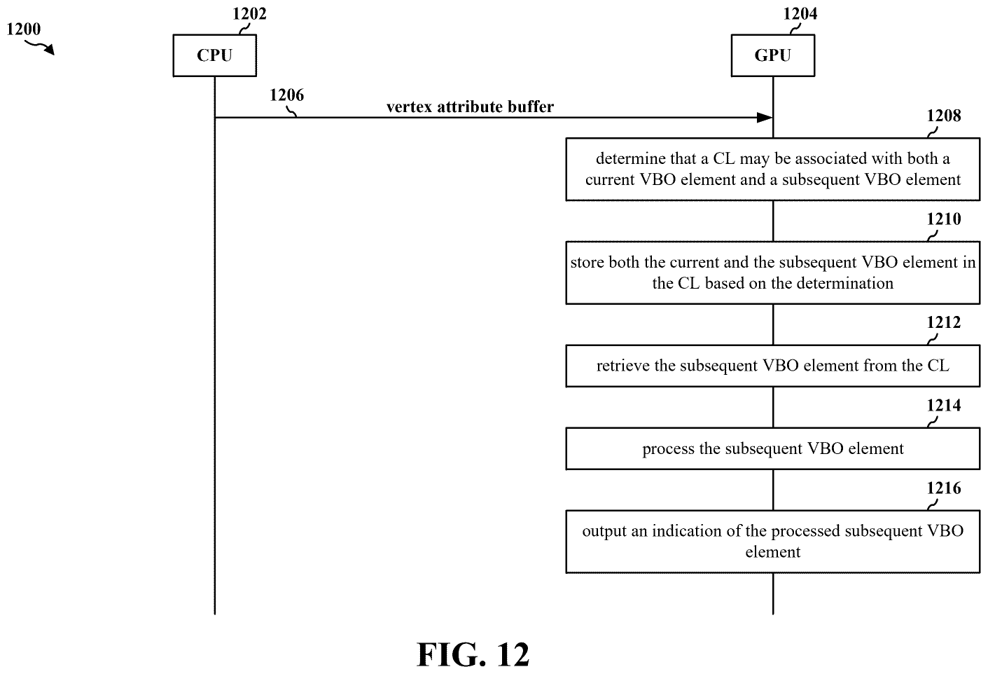

FIG. 12 is a call flow diagram 1200 illustrating example communications between a CPU 1202 and a GPU 1204. The CPU 1202 may transmit an indication of a vertex attribute buffer 1206 to the GPU 1204. The GPU 1204 may receive the indication of the vertex attribute buffer 1206 from the CPU 1202. At 1208, the GPU 1204 may determine whether a CL may be associated with both a current VBO element and a subsequent VBO element. For example, the GPU 1204 may use any of the checks enumerated in FIGS. 9-11. If the GPU 1204 determines that the CL may hold both the current VBO element and the subsequent VBO element, then at 1210, the GPU 1204 may store both the current and the subsequent VBO element in the CL based on the determination. As the portion of the vertex attribute buffer 1206 that is stored in the CL is logically contiguous, the CL may also include VBO elements that are in between the current and subsequent VBO element, as well as VBO elements that fit within the CL that are before the current VBO element in the vertex attribute buffer 1206, and/or after the subsequent VBO element in the vertex attribute buffer 1206. When the GPU 1204 is processing the subsequent VBO, at 1212, the GPU 1204 may retrieve the subsequent VBO element from the CL. At 1214, the GPU 1204 may process the subsequent VBO element, for example in a BV pass or a BR pass. At 1216, the GPU 1204 may output an indication of the processed subsequent VBO element.

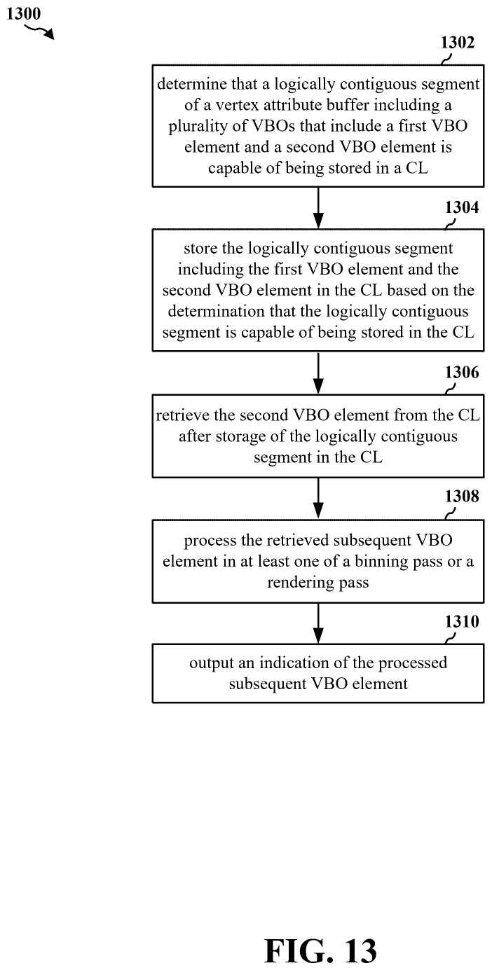

FIG. 13 is a flowchart 1300 of an example method of graphics processing in accordance with one or more techniques of this disclosure. The method may be performed by an apparatus, such as an apparatus for graphics processing, a GPU, a CPU a wireless communication device, and the like, as used in connection with the aspects of FIG. 1-3, 4A, 4B, 5A, 5B, 6A, 6B, 7A, 7B, 8A, 8B, or 9-12.

At 1302, the apparatus may determine that a logically contiguous segment of a vertex attribute buffer including a plurality of VBOs that include a first VBO element and a second VBO element is capable of being stored in a CL. For example, 1302 may be performed by the GPU 1204 in FIG. 12, which may, at 1208, determine that a logically contiguous segment of a vertex attribute buffer including a plurality of VBOs that include a first VBO element and a second VBO element is capable of being stored in a CL. Moreover, 1302 may be performed by the cache optimizer 198 in FIG. 1.

At 1304, the apparatus may store the logically contiguous segment including the first VBO element and the second VBO element in the CL based on the determination that the logically contiguous segment is capable of being stored in the CL. For example, 1304 may be performed by the GPU 1204 in FIG. 12, which may, at 1210, store the logically contiguous segment including the first VBO element and the second VBO element in the CL based on the determination at 1208. Moreover, 1304 may be performed by the cache optimizer 198 in FIG. 1.

At 1306, the apparatus may retrieve the second VBO element from the CL after storage of the logically contiguous segment in the CL. For example, 1302 may be performed by the GPU 1204 in FIG. 12, which may, at 1212, retrieve the second VBO element from the CL after the storage at 1210. Moreover, 1306 may be performed by the cache optimizer 198 in FIG. 1.

At 1308, the apparatus may process the retrieved subsequent VBO element in at least one of a binning pass or a rendering pass. For example, 1308 may be performed by the GPU 1204 in FIG. 12, which may, at 1214, process the retrieved subsequent VBO element in at least one of a binning pass or a rendering pass. Moreover, 1308 may be performed by the cache optimizer 198 in FIG. 1.

At 1310, the apparatus may output an indication of the processed subsequent VBO element. For example, 1310 may be performed by the GPU 1204 in FIG. 12, which may, at 1216, output an indication of the processed subsequent VBO element. For example the GPU 1204 may store the indication on a memory, or may transmit the indication to another component. Moreover, 1310 may be performed by the cache optimizer 198 in FIG. 1.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for determining that a logically contiguous segment of a vertex attribute buffer including a plurality of VBOs that include a first VBO element and a second VBO element is capable of being stored in a CL. The apparatus may include means for storing the logically contiguous segment including the first VBO element and the second VBO element in the CL based on the determination that the logically contiguous segment is capable of being stored in the CL. The apparatus may include means for retrieving the second VBO element from the CL after storage of the logically contiguous segment in the CL. The apparatus may include means for processing the retrieved second VBO element in at least one of a binning pass or a rendering pass. The apparatus may include means for outputting an indication of the processed second VBO element. The apparatus may include means for outputting the indication of the processed second VBO element by (a) storing the indication of the processed second VBO element or (b) transmitting the indication of the processed second VBO element. The plurality of VBOs may include at least one of: a vertex specific attribute; an instance specific attribute; or an instanced attribute. A first type of the first VBO element may be different than a second type of the second VBO element. The apparatus may include means for determining that the logically contiguous segment of the vertex attribute buffer including the plurality of VBOs is capable of being stored in the CL before storage of the logically contiguous segment in the CL. The vertex attribute buffer may include a plurality of instance specific attributes. The apparatus may include means for determining that the logically contiguous segment of the vertex attribute buffer including the plurality of VBOs is capable of being stored in the CL by (a) determining a minimum instance identifier (ID) offset for any two instances of the vertex attribute buffer, and (b) determining that the CL is associated with the first VBO element and the second VBO element in response to the determined minimum instance ID offset being less than a size of the CL. The apparatus may include means for determining the minimum instance ID offset for any two instances of the vertex attribute buffer by multiplying a VBO stride of the vertex attribute buffer with a minimum offset between any two instance specific attributes of the plurality of instance specific attributes. The vertex attribute buffer may include a plurality of instance specific attributes. The apparatus may include means for determining that the logically contiguous segment of the vertex attribute buffer including the plurality of VBOs is capable of being stored in the CL by (a) determining that the logically contiguous segment of the vertex attribute buffer including the plurality of VBOs is capable of being stored in the CL in response to a minimum offset between any two instance specific attributes of the plurality of instance specific attributes being less than a VBO step rate of the vertex attribute buffer. The vertex attribute buffer may include a plurality of instance specific attributes. The apparatus may include means for determining that the logically contiguous segment of the vertex attribute buffer including the plurality of VBOs is capable of being stored in the CL by (a) determining a minimum attribute offset for any two attributes of a first instance of the vertex attribute buffer, and (b) determining that the logically contiguous segment of the vertex attribute buffer including the plurality of VBOs is capable of being stored in the CL in response to the determined minimum attribute offset being less than a size of the CL. The vertex attribute buffer may include a plurality of vertex specific attributes. The apparatus may include means for determining that the logically contiguous segment of the vertex attribute buffer including the plurality of VBOs is capable of being stored in the CL by (a) determining a minimum instance ID offset for any two instances of the vertex attribute buffer, and (b) determining that the logically contiguous segment of the vertex attribute buffer including the plurality of VBOs is capable of being stored in the CL in response to the determined minimum attribute offset being less than a size of the CL. The apparatus may include means for determining the minimum instance ID offset for any two instances of the vertex attribute buffer by multiplying a VBO stride of the vertex attribute buffer with a minimum offset between any two vertex specific attributes of the plurality of instance specific attributes. The vertex attribute buffer may include a plurality of vertex specific attributes. The apparatus may include means for determining that the logically contiguous segment of the vertex attribute buffer including the plurality of VBOs is capable of being stored in the CL by determining that the logically contiguous segment of the vertex attribute buffer including the plurality of VBOs is capable of being stored in the CL in response to an instance count of the vertex attribute buffer being greater than one. The vertex attribute buffer may include a plurality of vertex specific attributes. The apparatus may include means for determining that the logically contiguous segment of the vertex attribute buffer including the plurality of VBOs is capable of being stored in the CL by (a) determining a minimum attribute offset for any two attributes of a first vertex of the vertex attribute buffer, and (b) determining that the logically contiguous segment of the vertex attribute buffer including the plurality of VBOs is capable of being stored in the CL in response to the determined minimum attribute offset being less than a size of the CL. The apparatus may include means for determining that the logically contiguous segment of the vertex attribute buffer including the plurality of VBOs is capable of being stored in the CL by (a) comparing a first draw call associated with the first VBO element with a second draw call associated with the second VBO element, and (b) determining that the logically contiguous segment of the vertex attribute buffer including the plurality of VBOs is capable of being stored in the CL in response to the first draw call and the second draw call using a same buffer for the first VBO element and the second VBO element. The apparatus may include means for obtaining an indication of the vertex attribute buffer before the determination of whether the logically contiguous segment of the vertex attribute buffer including the plurality of VBOs is capable of being stored in the CL. The apparatus may include means for obtaining an indication of a vertex attribute buffer including a plurality of VBOs. The apparatus may further include means for storing both a current VBO element and a subsequent VBO element in a CL based on a determination that the CL is associated with the current VBO element and the subsequent VBO element. The apparatus may further include means for retrieving the subsequent VBO element from the CL in response to a storage of both the current VBO element and the subsequent VBO element in the CL. The apparatus may further include means for processing the retrieved subsequent VBO element in at least one of a binning pass or a rendering pass. The apparatus may further include means for outputting an indication of the processed subsequent VBO element.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.
Aspect 1 is a method of graphics processing, comprising: determining that a logically contiguous segment of a vertex attribute buffer comprising a plurality of vertex buffer objects (VBOs) that include a first VBO element and a second VBO element is capable of being stored in a cache line (CL); storing the logically contiguous segment comprising the first VBO element and the second VBO element in the CL based on the determination that the logically contiguous segment is capable of being stored in the CL; retrieving the second VBO element from the CL after storage of the logically contiguous segment in the CL; processing the retrieved second VBO element in at least one of a binning pass or a rendering pass; and outputting an indication of the processed second VBO element. By retrieving the second VBO element from the CL, the method may fetch the second VBO element from the CL instead of a slower memory, for example system memory or off-chip memory.
Aspect 2 is the method of aspect 1, wherein outputting the indication of the processed second VBO element comprises: storing the indication of the processed second VBO element; or transmitting the indication of the processed second VBO element.
Aspect 3 is the method of either of aspects 1 or 2, wherein the plurality of VBOs comprises at least one of: a vertex specific attribute; an instance specific attribute; or an instanced attribute.
Aspect 4 is the method of any of aspects 1 to 3, wherein a first type of the first VBO element is different than a second type of the second VBO element. In other words, a subset of a draw call may match a subsequent GPU instance.
Aspect 5 is the method of any of aspects 1 to 4, further comprising: determining that the logically contiguous segment of the vertex attribute buffer comprising the plurality of VBOs is capable of being stored in the CL before storage of the logically contiguous segment in the CL.
Aspect 6 is the method of aspect 5, wherein the vertex attribute buffer comprises a plurality of instance specific attributes, wherein determining that the logically contiguous segment of the vertex attribute buffer comprising the plurality of VBOs is capable of being stored in the CL comprises: determining a minimum instance identifier (ID) offset for any two instances of the vertex attribute buffer; and determining that the CL is associated with the first VBO element and the second VBO element in response to the determined minimum instance ID offset being less than a size of the CL. For example, the determination may be made in response to a min_VBO_offset value being less than the CL_width of the CL.
Aspect 7 is the method of aspect 6, wherein determining the minimum instance ID offset for any two instances of the vertex attribute buffer comprises: multiplying a VBO stride of the vertex attribute buffer with a minimum offset between any two instance specific attributes of the plurality of instance specific attributes. For example, the min_VBO_offset value may be calculated as a product of the min_instance_ID_offset value and the VBO_stride value.
Aspect 8 is the method of any of aspects 5 to 7, wherein the vertex attribute buffer comprises a plurality of instance specific attributes, wherein determining that the logically contiguous segment of the vertex attribute buffer comprising the plurality of VBOs is capable of being stored in the CL comprises: determining that the logically contiguous segment of the vertex attribute buffer comprising the plurality of VBOs is capable of being stored in the CL in response to a minimum offset between any two instance specific attributes of the plurality of instance specific attributes being less than a VBO step rate of the vertex attribute buffer. In other words, the determination may be made in response to the min_instance_ID_offset value being less than a steprate.
Aspect 9 is the method of any of aspects 5 to 8, wherein the vertex attribute buffer comprises a plurality of instance specific attributes, wherein determining that the logically contiguous segment of the vertex attribute buffer comprising the plurality of VBOs is capable of being stored in the CL comprises: determining a minimum attribute offset for any two attributes of a first instance of the vertex attribute buffer; and determining that the logically contiguous segment of the vertex attribute buffer comprising the plurality of VBOs is capable of being stored in the CL in response to the determined minimum attribute offset being less than a size of the CL. In other words, the determination may be made in response to the min_next_attribute_offset value being less than a CL_width of the CL. In some aspects, the method may iterate from A0-Aq for a single instance.
Aspect 10 is the method of any of aspects 5 to 9, wherein the vertex attribute buffer comprises a plurality of vertex specific attributes, wherein determining that the logically contiguous segment of the vertex attribute buffer comprising the plurality of VBOs is capable of being stored in the CL comprises: determining a minimum instance identifier (ID) offset for any two instances of the vertex attribute buffer; and determining that the logically contiguous segment of the vertex attribute buffer comprising the plurality of VBOs is capable of being stored in the CL in response to the determined minimum attribute offset being less than a size of the CL. In other words, the determination may be made in response to a min_VBO_offset value being less than a CL_width of a CL.
Aspect 11 is the method of aspect 10, wherein determining the minimum instance ID offset for any two instances of the vertex attribute buffer comprises: multiplying a VBO stride of the vertex attribute buffer with a minimum offset between any two vertex specific attributes of the plurality of instance specific attributes. For example, a min_VBO_offset value may be calculated as a product of the min_vertex_ID_offset and the VBO_stride.
Aspect 12 is the method of any of aspects 5 to 11, wherein the vertex attribute buffer comprises a plurality of vertex specific attributes, wherein determining that the logically contiguous segment of the vertex attribute buffer comprising the plurality of VBOs is capable of being stored in the CL comprises: determining that the logically contiguous segment of the vertex attribute buffer comprising the plurality of VBOs is capable of being stored in the CL in response to an instance count of the vertex attribute buffer being greater than one. In other words, so long as an instance_cnt value is greater than one, the method may determine that the logically contiguous segment of the vertex attribute buffer may be capable of being stored in the CL. In other words, multiple instances may use the same vertex data. The instance_cnt value may be obtained as part of a draw call state.
Aspect 13 is the method of any of aspects 5 to 12, wherein the vertex attribute buffer comprises a plurality of vertex specific attributes, wherein determining that the logically contiguous segment of the vertex attribute buffer comprising the plurality of VBOs is capable of being stored in the CL comprises: determining a minimum attribute offset for any two attributes of a first vertex of the vertex attribute buffer; and determining that the logically contiguous segment of the vertex attribute buffer comprising the plurality of VBOs is capable of being stored in the CL in response to the determined minimum attribute offset being less than a size of the CL. In other words, the determination may be made so long as a min_next_attribute_offset value is less than a CL_width of the CL. The method may iterate through attributes from A0 to Ap for a single vertex.
Aspect 14 is the method of any of aspects 5 to 13, wherein determining that the logically contiguous segment of the vertex attribute buffer comprising the plurality of VBOs is capable of being stored in the CL comprises: comparing a first draw call associated with the first VBO element with a second draw call associated with the second VBO element; and determining that the logically contiguous segment of the vertex attribute buffer comprising the plurality of VBOs is capable of being stored in the CL in response to the first draw call and the second draw call using a same buffer for the first VBO element and the second VBO element. In other words, the determination may be made if the method determines that a VBO will be reused in a subsequent call while the same CL is being used. In some aspects, the determination may be made if a VBO is shared between two draws. The method may check a VBO address and index/vertex offsets for N number of draw calls to determine if a reuse is possible in the same CL, where the number N may be predefined by the system (e.g., defined in a standard or specification).
Aspect 15 is the method of any of aspects 1 to 14, further comprising: obtaining an indication of the vertex attribute buffer before the determination of whether the logically contiguous segment of the vertex attribute buffer comprising the plurality of VBOs is capable of being stored in the CL.
Aspect 16 is a method of graphics processing, comprising: storing both a current VBO element and a subsequent VBO element in a cache line (CL) based on a determination that the CL is associated with the current VBO element and the subsequent VBO element; retrieving the subsequent VBO element from the CL in response to a storage of both the current VBO element and the subsequent VBO element in the CL;
processing the retrieved subsequent VBO element in at least one of a binning pass or a rendering pass; and outputting an indication of the processed subsequent VBO element.
Aspect 17 is the method of aspect 16, wherein outputting the indication of the processed subsequent VBO element comprises: storing the indication of the processed subsequent VBO element; or transmitting the indication of the processed subsequent VBO element.
Aspect 18 is the method of either of aspects 16 or 17, wherein the plurality of VBOs comprises at least one of: a draw call; a vertex; a vertex attribute; or a VBO instance.
Aspect 19 is the method of any of aspects 16 to 18, wherein a first type of the current VBO element is different than a second type of the subsequent VBO element.
Aspect 20 is the method of any of aspects 16 to 19, further comprising: determining whether the CL is associated with the current VBO element and the subsequent VBO element of the plurality of VBOs before the storage of both the current VBO element and the subsequent VBO element in the CL.
Aspect 21 is the method of aspect 20, wherein the vertex attribute buffer comprises a plurality of instance specific attributes, wherein determining whether the CL is associated with the current VBO element and the subsequent VBO element of the plurality of VBOs comprises: determining a minimum instance identifier (ID) offset for any two instances of the vertex attribute buffer; and determining that the CL is associated with the current VBO element and the subsequent VBO element in response to the determined minimum instance ID offset being less than a size of the CL.
Aspect 22 is the method of aspect 21, wherein determining the minimum instance ID offset for any two instances of the vertex attribute buffer comprises: multiplying a VBO stride of the vertex attribute buffer with a minimum offset between any two instance specific attributes of the plurality of instance specific attributes.
Aspect 23 is the method of any of aspects 20 to 22, wherein the vertex attribute buffer comprises a plurality of instance specific attributes, wherein determining whether the CL is associated with the current VBO element and the subsequent VBO element of the plurality of VBOs comprises: determining that the CL is associated with the current VBO element and the subsequent VBO element in response to a minimum offset between any two instance specific attributes of the plurality of instance specific attributes being less than a VBO step rate of the vertex attribute buffer.
Aspect 24 is the method of any of aspects 20 to 23, wherein the vertex attribute buffer comprises a plurality of instance specific attributes, wherein determining whether the CL is associated with the current VBO element and the subsequent VBO element of the plurality of VBOs comprises: determining a minimum attribute offset for any two attributes of a first instance of the vertex attribute buffer; and determining that the CL is associated with the current VBO element and the subsequent VBO element in response to the determined minimum attribute offset being less than a size of the CL.
Aspect 25 is the method of any of aspects 20 to 24, wherein the vertex attribute buffer comprises a plurality of vertex specific attributes, wherein determining whether the CL is associated with the current VBO element and the subsequent VBO element of the plurality of VBOs comprises: determining a minimum instance identifier (ID) offset for any two instances of the vertex attribute buffer; and determining that the CL is associated with the current VBO element and the subsequent VBO element in response to the determined minimum attribute offset being less than a size of the CL.
Aspect 26 is the method of aspect 25, wherein determining the minimum instance ID offset for any two instances of the vertex attribute buffer comprises: multiplying a VBO stride of the vertex attribute buffer with a minimum offset between any two vertex specific attributes of the plurality of instance specific attributes.
Aspect 27 is the method of any of aspects 20 to 26, wherein the vertex attribute buffer comprises a plurality of vertex specific attributes, wherein determining whether the CL is associated with the current VBO element and the subsequent VBO element of the plurality of VBOs comprises: determining that the CL is associated with the current VBO element and the subsequent VBO element in response to an instance count of the vertex attribute buffer being greater than one. For example, a processor may obtain the instance count (e.g., instance_cnt) from a draw call state.
Aspect 28 is the method of any of aspects 20 to 27, wherein the vertex attribute buffer comprises a plurality of vertex specific attributes, wherein determining whether the CL is associated with the current VBO element and the subsequent VBO element of the plurality of VBOs comprises: determining a minimum attribute offset for any two attributes of a first vertex of the vertex attribute buffer; and determining that the CL is associated with the current VBO element and the subsequent VBO element in response to the determined minimum attribute offset being less than a size of the CL.
Aspect 29 is the method of any of aspects 20 to 28, wherein determining whether the CL is associated with the current VBO element and the subsequent VBO element of the plurality of VBOs comprises: comparing a current draw call associated with the current VBO element with a subsequent draw call associated with the subsequent VBO element; and determining that the CL is associated with the current VBO element and the subsequent VBO element in response to the current draw call and the subsequent draw call using a same buffer for the current VBO element and the subsequent VBO element.
Aspect 30 is the method of any of aspects 16 to 29, further comprising: obtaining an indication of a vertex attribute buffer comprising a plurality of vertex buffer objects (VBOs).
Aspect 31 is an apparatus for graphics processing including at least one processor coupled to a memory and configured to implement a method as in any of aspects 1-30.
Aspect 32 may be combined with aspect 31 and includes that the apparatus is a wireless communication device.
Aspect 33 is an apparatus for [graphics/display] processing including means for implementing a method as in any of aspects 1-30.
Aspect 34 is a computer-readable medium storing computer executable code, the code when executed by at least one processor causes the at least one processor to implement a method as in any of aspects 1-30.

Various aspects have been described herein. These and other aspects are within the scope of the following claims.

What is claimed is:

1. An apparatus for graphics processing, comprising:
a memory; and
a processor coupled to the memory and, based at least in part on information stored in the memory, the processor is configured to:
determine that a logically contiguous segment of a vertex attribute buffer comprising a plurality of vertex buffer objects (VBOs) that include a first VBO element and a second VBO element is capable of being stored in a cache line (CL);
store the logically contiguous segment comprising the first VBO element and the second VBO element in the CL based on the determination that the logically contiguous segment is capable of being stored in the CL;
retrieve the second VBO element from the CL after storage of the logically contiguous segment in the CL;
process the retrieved second VBO element in at least one of a binning pass or a rendering pass; and
output an indication of the processed second VBO element.

2. The apparatus of claim 1, wherein, to output the indication of the processed second VBO element, the processor is configured to:
store the indication of the processed second VBO element; or
transmit the indication of the processed second VBO element.

3. The apparatus of claim 1, wherein the plurality of VBOs comprises at least one of:
a vertex specific attribute;
an instance specific attribute; or
an instanced attribute.

4. The apparatus of claim 1, wherein a first type of the first VBO element is different than a second type of the second VBO element.

5. The apparatus of claim 1, wherein the processor is further configured to:
determine that the logically contiguous segment of the vertex attribute buffer comprising the plurality of VBOs is capable of being stored in the CL before storage of the logically contiguous segment in the CL.

6. The apparatus of claim 5, wherein the vertex attribute buffer comprises a plurality of instance specific attributes, wherein, to determine that the logically contiguous segment of the vertex attribute buffer comprising the plurality of VBOs is capable of being stored in the CL, the processor is configured to:
determine a minimum instance identifier (ID) offset for any two instances of the vertex attribute buffer; and
determine that the CL is associated with the first VBO element and the second VBO element in response to the determined minimum instance ID offset being less than a size of the CL.

7. The apparatus of claim 6, wherein, to determine the minimum instance ID offset for any two instances of the vertex attribute buffer, the processor is configured to:
multiply a VBO stride of the vertex attribute buffer with a minimum offset between any two instance specific attributes of the plurality of instance specific attributes.

8. The apparatus of claim 5, wherein the vertex attribute buffer comprises a plurality of instance specific attributes, wherein, to determine that the logically contiguous segment of the vertex attribute buffer comprising the plurality of VBOs is capable of being stored in the CL, the processor is configured to:
determine that the logically contiguous segment of the vertex attribute buffer comprising the plurality of VBOs is capable of being stored in the CL in response to a minimum offset between any two instance specific attributes of the plurality of instance specific attributes being less than a VBO step rate of the vertex attribute buffer.

9. The apparatus of claim 5, wherein the vertex attribute buffer comprises a plurality of instance specific attributes, wherein, to determine that the logically contiguous segment of the vertex attribute buffer comprising the plurality of VBOs is capable of being stored in the CL, the processor is configured to:
determine a minimum attribute offset for any two attributes of a first instance of the vertex attribute buffer; and
determine that the logically contiguous segment of the vertex attribute buffer comprising the plurality of VBOs is capable of being stored in the CL in response to the determined minimum attribute offset being less than a size of the CL.

10. The apparatus of claim 5, wherein the vertex attribute buffer comprises a plurality of vertex specific attributes, wherein, to determine that the logically contiguous segment of the vertex attribute buffer comprising the plurality of VBOs is capable of being stored in the CL, the processor is configured to:
determine a minimum instance identifier (ID) offset for any two instances of the vertex attribute buffer; and
determine that the logically contiguous segment of the vertex attribute buffer comprising the plurality of VBOs is capable of being stored in the CL in response to the determined minimum attribute offset being less than a size of the CL.

11. The apparatus of claim 10, wherein, to determine the minimum instance ID offset for any two instances of the vertex attribute buffer, the processor is configured to:
multiply a VBO stride of the vertex attribute buffer with a minimum offset between any two vertex specific attributes of the plurality of instance specific attributes.

12. The apparatus of claim 5, wherein the vertex attribute buffer comprises a plurality of vertex specific attributes, wherein, to determine that the logically contiguous segment of the vertex attribute buffer comprising the plurality of VBOs is capable of being stored in the CL, the processor is configured to:
determine the logically contiguous segment of the vertex attribute buffer comprising the plurality of VBOs is capable of being stored in the CL in response to an instance count of the vertex attribute buffer being greater than one.

13. The apparatus of claim 5, wherein the vertex attribute buffer comprises a plurality of vertex specific attributes, wherein, to determine that the logically contiguous segment of the vertex attribute buffer comprising the plurality of VBOs is capable of being stored in the CL, the processor is configured to:
determine a minimum attribute offset for any two attributes of a first vertex of the vertex attribute buffer; and
determine that the logically contiguous segment of the vertex attribute buffer comprising the plurality of VBOs is capable of being stored in the CL in response to the determined minimum attribute offset being less than a size of the CL.

14. The apparatus of claim 5, wherein, to determine that the logically contiguous segment of the vertex attribute buffer comprising the plurality of VBOs is capable of being stored in the CL, the processor is configured to:
compare a current draw call associated with the first VBO element with a second draw call associated with the second VBO element; and
determine that the logically contiguous segment of the vertex attribute buffer comprising the plurality of VBOs is capable of being stored in the CL in response to the current draw call and the second draw call using a same buffer for the first VBO element and the second VBO element.

15. A method of graphics processing, comprising:
determining that a logically contiguous segment of a vertex attribute buffer comprising a plurality of vertex buffer objects (VBOs) that include a first VBO element and a second VBO element is capable of being stored in a cache line (CL);
storing the logically contiguous segment comprising the first VBO element and the second VBO element in the CL based on the determination that the logically contiguous segment is capable of being stored in the CL;
retrieving the second VBO element from the CL after storage of the logically contiguous segment in the CL;
processing the retrieved second VBO element in at least one of a binning pass or a rendering pass; and
outputting an indication of the processed second VBO element.

16. The method of claim 15, further comprising:
determining that the logically contiguous segment of the vertex attribute buffer comprising the plurality of VBOs is capable of being stored in the CL before storage of the logically contiguous segment in the CL.

17. The method of claim 16, wherein the vertex attribute buffer comprises a plurality of instance specific attributes, wherein determining that the logically contiguous segment of the vertex attribute buffer comprising the plurality of VBOs is capable of being stored in the CL comprises:
determining a minimum instance identifier (ID) offset for any two instances of the vertex attribute buffer; and
determining that the CL is associated with the first VBO element and the second VBO element in response to the determined minimum instance ID offset being less than a size of the CL.

18. The method of claim 16, wherein the vertex attribute buffer comprises a plurality of instance specific attributes, wherein determining that the logically contiguous segment of the vertex attribute buffer comprising the plurality of VBOs is capable of being stored in the CL comprises:
determining a minimum attribute offset for any two attributes of a first instance of the vertex attribute buffer; and
determining that the logically contiguous segment of the vertex attribute buffer comprising the plurality of VBOs is capable of being stored in the CL in response to the determined minimum attribute offset being less than a size of the CL.

19. The method of claim 16, wherein the vertex attribute buffer comprises a plurality of vertex specific attributes, wherein determining that the logically contiguous segment of the vertex attribute buffer comprising the plurality of VBOs is capable of being stored in the CL comprises:
determining a minimum instance identifier (ID) offset for any two instances of the vertex attribute buffer; and
determining that the logically contiguous segment of the vertex attribute buffer comprising the plurality of VBOs is capable of being stored in the CL in response to the determined minimum attribute offset being less than a size of the CL.

20. A computer-readable medium storing computer executable code, the code when executed by a processor, causes the processor to:
determine that a logically contiguous segment of a vertex attribute buffer comprising a plurality of vertex buffer objects (VBOs) that include a first VBO element and a second VBO element is capable of being stored in a cache line (CL);
store the logically contiguous segment comprising the first VBO element and the second VBO element in the CL based on the determination that the logically contiguous segment is capable of being stored in the CL;
retrieve the second VBO element from the CL after storage of the logically contiguous segment in the CL;
process the retrieved second VBO element in at least one of a binning pass or a rendering pass; and
output an indication of the processed second VBO element.
